(19) United States
(12) Patent Application Publication
(10) Pub. No.: US 2024/0190642 A1
(43) Pub. Date: Jun. 13, 2024

(54) TRELLIS MOVER AND METHODS OF PROVIDING AND USING THE SAME

(71) Applicant: Growers House Operations, LLC, Tucson, AZ (US)

(72) Inventor: Nate Lipton, Tucson, AZ (US)

(73) Assignee: Growers House Operations, LLC, Tucson, AZ (US)

(21) Appl. No.: 18/583,622

(22) Filed: Feb. 21, 2024

Related U.S. Application Data
(60) Provisional application No. 63/526,888, filed on Jul. 14, 2023.

(51) Int. Cl. B65D 85/67; A01G 17/06

(52) U.S. Cl. CPC B65D 85/67; A01G 17/06

(57) ABSTRACT

A dispensing rack includes a first stand, a second stand, and a movable base. The first and second stands are configured to hold multiple rolls and dispense multiple layers simultaneously from the multiple rolls. Other embodiments are described.

### CROSS-REFERENCE TO RELATED APPLICATION

This application claims the benefit of U.S. Provisional Application No. 63/526,888, filed Jul. 14, 2023. U.S. Provisional Application No. 63/526,888 is incorporated herein by reference in its entirety.

### TECHNICAL FIELD

This disclosure relates generally to movable dispensers and related apparatuses and methods.

### BACKGROUND

A trellis generally provides an open framework or lattice to support, facilitate growth of, and/or display plants, such as shrubs, vines, ivy, Cannabis plants, and/or other climbing plants. A trellis can provide the support to optimize growth of such plants and is often used in commercial agricultural cultivation. Conventionally, a trellis is often made of plastic, such as polyethylene, polypropylene, or another suitable plastic, and dispensed from a roll of trellis.

### BRIEF DESCRIPTION OF THE DRAWINGS

To facilitate further description of the embodiments, the following drawings are provided in which:

FIG. 1 illustrates a front view of a trellis mover, according to an embodiment;

FIG. 2 illustrates a side view of the trellis mover of FIG. 1;

FIG. 3 illustrates a perspective view of a base of the trellis mover of FIG. 1;

FIG. 4 illustrates a top view of a cross brace of the trellis mover of FIG. 1;

FIG. 5 illustrates a top view of a net guide of the trellis mover of FIG. 1;

FIG. 6 illustrates a stand of the trellis mover of FIG. 1;

FIG. 7 illustrates a front view of a trellis mover, according to another embodiment;

FIG. 8 illustrates a side view of the trellis mover of FIG. 7;

FIG. 9 illustrates an example of an eyelet on a brace, according to an embodiment;

FIG. 10 illustrates using the trellis mover of FIG. 7 to dispense multiple rolls of trellis at a set height;

FIG. 11 illustrates an example of dispense three rolls of trellis in layers in an indoor greenhouse;

FIG. 12 illustrates the trellis mover of FIG. 1 dispensing the three rolls of trellis of FIG. 11 in layers in the indoor greenhouse of FIG. 11;

FIG. 13 illustrates a rear view of a trellis mover, according to another embodiment;

FIG. 14 illustrates moving the trellis mover of FIG. 13 through an passageway; and

FIG. 15 illustrates the base of the trellis mover of FIG. 13.

For simplicity and clarity of illustration, the drawings and figures herein illustrate the general manner of the systems, methods, and construction, and descriptions and details of well-known features and techniques may be omitted to avoid unnecessarily obscuring the invention. Additionally, elements in the drawings and figures are not necessarily drawn to scale. For example, the dimensions of some of the elements, steps, and features in the figures may be exaggerated relative to other elements, steps, and features, to help improve understanding of embodiments of the present invention. The same reference numerals in different figures denote the same elements.

The terms “first,” “second,” “third,” “fourth,” and the like in the description and in the claims, if any, are used for distinguishing between similar elements and features and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a dispensing rack, which includes a first stand, a second stand, and a movable base. The first and second stands are configured to hold multiple rolls and dispense multiple layers simultaneously from the multiple rolls.

A number of embodiments include a method of providing a dispensing rack. The method includes providing a first stand, providing a second stand, and providing a movable base. The first and second stands are configured to hold multiple rolls and dispense multiple layers simultaneously from the multiple rolls.

Further embodiments include a method of using a dispensing rack. The method includes dispensing multiple layers simultaneously from a dispensing rack that includes a first stand, a second stand, and a movable base. The first and second stands are configured to hold multiple rolls and dispense the multiple layers simultaneously from multiple rolls.

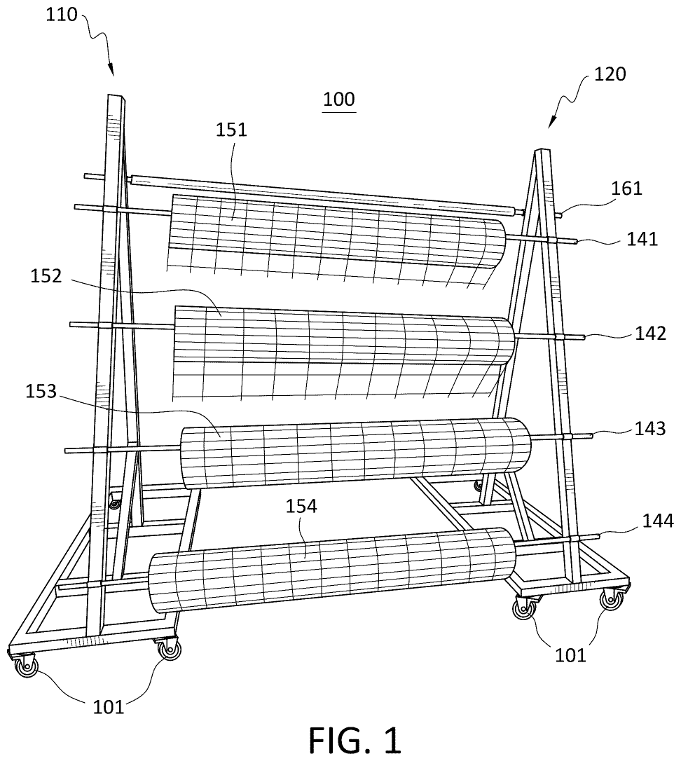

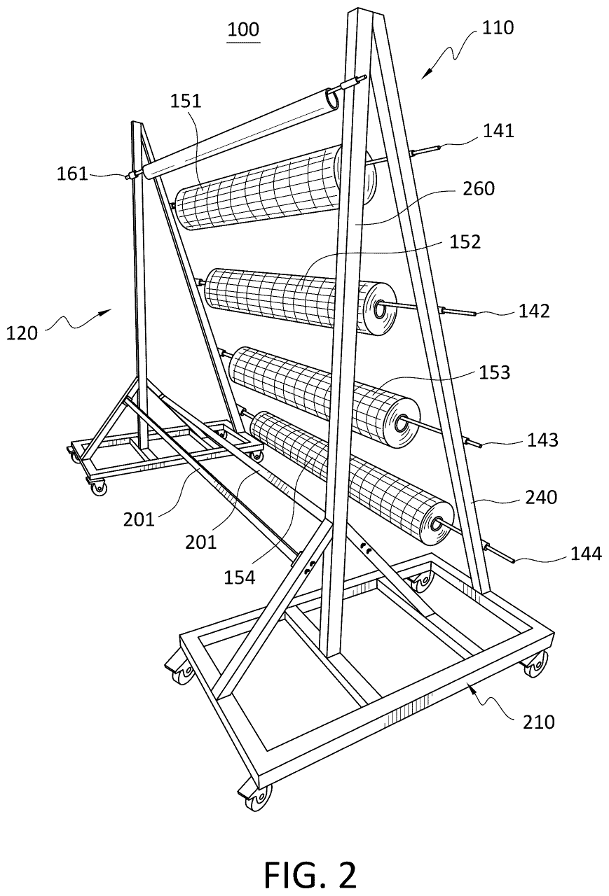

FIG. 1 illustrates a front view of a trellis mover 100, according to an embodiment. FIG. 2 illustrates a side view of trellis mover 100. Trellis mover 100 is merely exemplary, and embodiments of the trellis mover are not limited to the embodiments presented herein. The trellis mover can include many different embodiments or examples not specifically depicted or described herein. As shown in the FIGS. 1-2, trellis mover 100 (e.g., movable trellis rack) can hold multiple rolls of trellis, such as rolls 151-154, and facilitate dispensing such trellis.

A trellis generally provides an open framework or lattice to support, facilitate growth of, and/or display plants, such as shrubs, vines, ivy, Cannabis plants, and/or other climbing plants. A trellis can provide support to optimize growth of such plants, and are often used in commercial agricultural cultivation. Conventionally, a trellis can be made of wood, metal, or plastic. A plastic trellis is often an extrusive mesh of a plastic, such as polyethylene, polypropylene, or another suitable plastic. The mesh typically has openings in which the plants grow. Some plants, such as Cannabis plants, can benefit from growing with multiple layers of trellis netting each at a different height. In large greenhouses, dispensing such trellis netting can involve significant labor. In many embodiments, trellis mover 100 can facilitate dispensing multiple rolls of trellis (e.g., 151-154) simultaneously, and in some embodiments, one or more net guides (e.g., 141-144, 161) on trellis mover 100 can be used to facilitate dispensing the trellis at set or configurable positions (e.g., heights). As shown in FIGS. 1-2, trellis mover 100 can be mobile through wheels (e.g., 101) or another suitable mechanism.

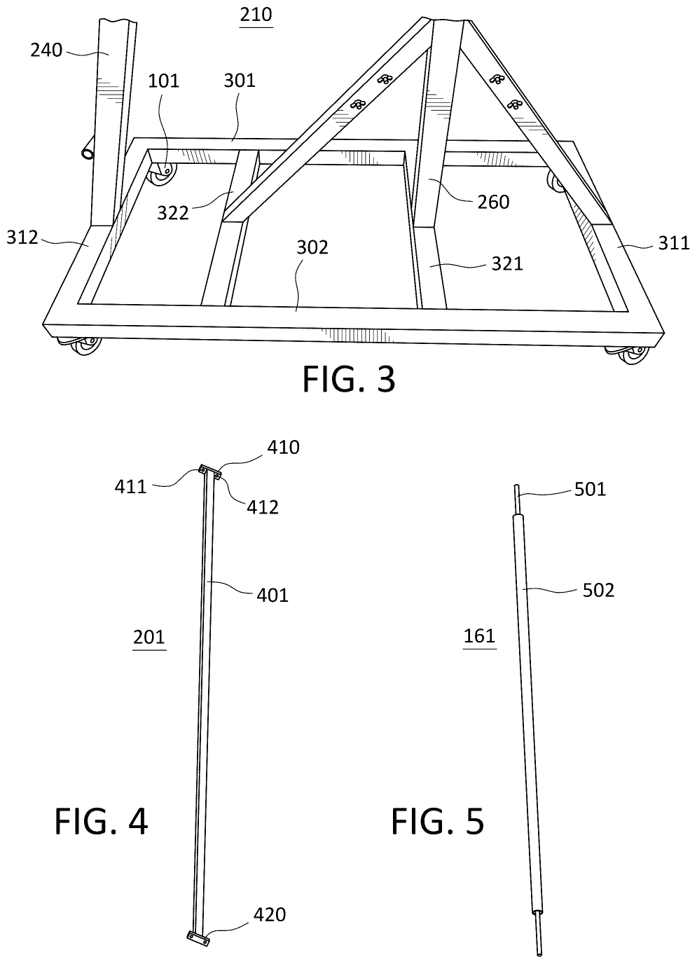

Trellis mover 100 can include two stands (e.g., 110, 120) that each can include various elements. For example, the stand (e.g., 110, 120) can include a base (e.g., 210), such as shown in more detail in FIG. 3, which can include wheels (e.g., 1010) mounted at each of the four corners to facilitate moving the base (e.g., 210). For example, as shown in FIG. 3, side pieces 301-302 can extend between end pieces 311-312, and support pieces 321-322 can extend between side pieces 301-302. In some embodiments, side pieces 301-302 each can be 48 inches long, or another suitable dimension, end pieces 311-312 each can be 24 inches long, or another suitable dimension, and support pieces 312-322 can be 20 inches long, or another suitable dimension.

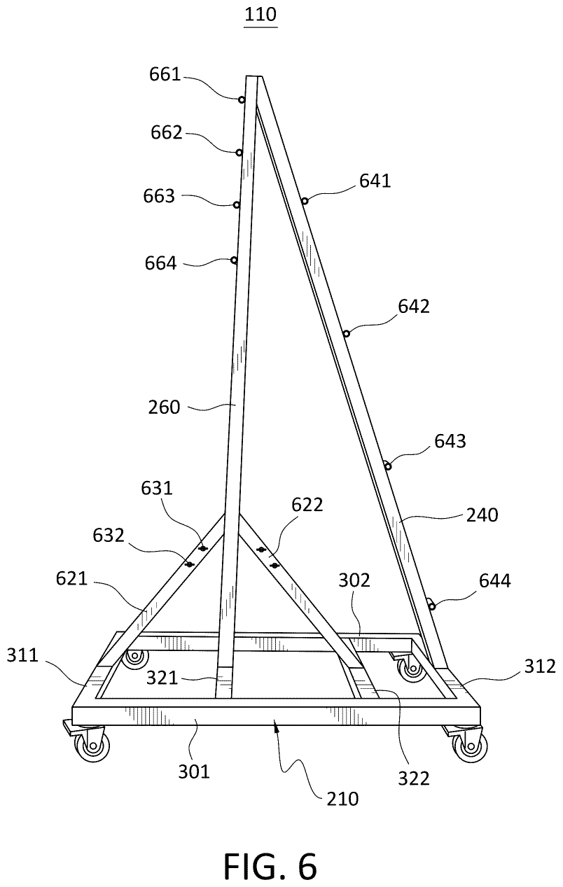

As shown in FIG. 2, in some embodiments, the stands (e.g., 110, 120) can be joined together by one or more cross braces 201, such as shown in more detail in FIG. 4. As shown in FIG. 4, cross brace 201 can include an extending piece 401 and end pieces 410 and 420 that extend perpendicular to extending piece 401 at the ends of extending piece 401. In some embodiments, the end pieces (e.g., 410, 420) can include holes 411-412 to be fastened to the stands (e.g., 110, 120), such as on diagonal base supports 621-622, as shown in FIG. 6 and described below. In some embodiments, extending pieces can be 84 inches long or another suitable length. In some embodiments, end pieces each can be 4 inches long, or another suitable length.

As shown in FIGS. 2, 3, and 6, the stand (e.g., 110) can include a diagonal brace (e.g., 240) and a center brace (e.g., 260). As shown in FIG. 6, diagonal brace 240 can include eyelets 641-644, or other suitable attachment mechanisms, which can be used to hold the net guides (e.g., 141-144 (FIGS. 1-2)) and/or the rolls of trellis (e.g., 151-154 (FIG. 1-2)). As shown in FIG. 6, center brace 260 can include eyelets 661-664, or other suitable attachment mechanisms, which can be used to hold the net guides (e.g., 161 (FIGS. 1-2)). In some embodiments, the net guides (e.g., 141-144, 161 (FIGS. 1-2)) installed in one of the braces (e.g., diagonal brace 240 or center brace 260) can serve as axles for the rolls of trellis (e.g., 151-154 (FIGS. 1-2)), to hold the rolls between each stand (e.g., 110, 120) and facilitate unrolling of the rolls of trellis (e.g., 151-154 (FIGS. 1-2)). In the same or other embodiments, the net guides (e.g., 141-144, 161 (FIGS. 1-2)) can be used on the other brace (e.g., 240, 260) to set dispensing levels for the rolls of trellis (e.g., 151-154 (FIGS. 1-2)). For example, eyelets 641-644 can be spaced 19 inches apart (or another suitable spacing) on diagonal brace 240, with eyelet 641 located 20 inches (or another suitable distance) below a top end of diagonal brace 240, and eyelet 644 located 8 inches (or another suitable distance) above a bottom end of diagonal brace 240. As another example, eyelets 661-664 can be spaced 7 inches apart (or another suitable spacing) on center brace 260, with eyelet 661 located 4 inches (or another suitable distance) below a top end of center brace 260.

An example of net guide 161 is shown in more detail in FIG. 5. In some embodiments, net guide 161 can include a rod (or pipe) 501, which can be metal, and which can be covered with a plastic pipe 502 (e.g., PVC pipe). For example, rod 501 can be 95 inches long or another suitable length, and plastic pipe 502 can be 80 inches long or another suitable length.

In many embodiments, the stand (e.g., 110, 120) can include brace supports (e.g., 621-622), such as shown in FIG. 6, which can support center brace 260, and/or which can be attached to cross braces 201 (FIGS. 2, 4), such as using holes 631-632 for bolts, to join together the two stands (e.g., 110, 120). In some embodiments, brace support 622 can extend from center brace 260 to support piece 322 on base 210, and can be 25 inches long or another suitable length. In some embodiments, brace support 621 can extend from center brace 260 to end piece 311 on base 210. In some embodiments, brace support 621 can be 27 inches long or another suitable length, hole 631 can be 6 inches below a top of brace support 621, and holes 631-632 can be spaced 8 inches (or another suitable spacing).

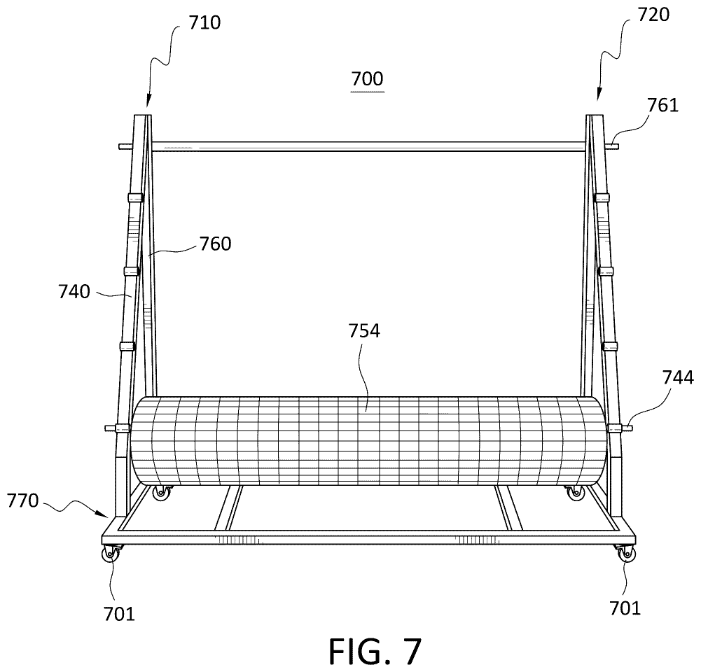

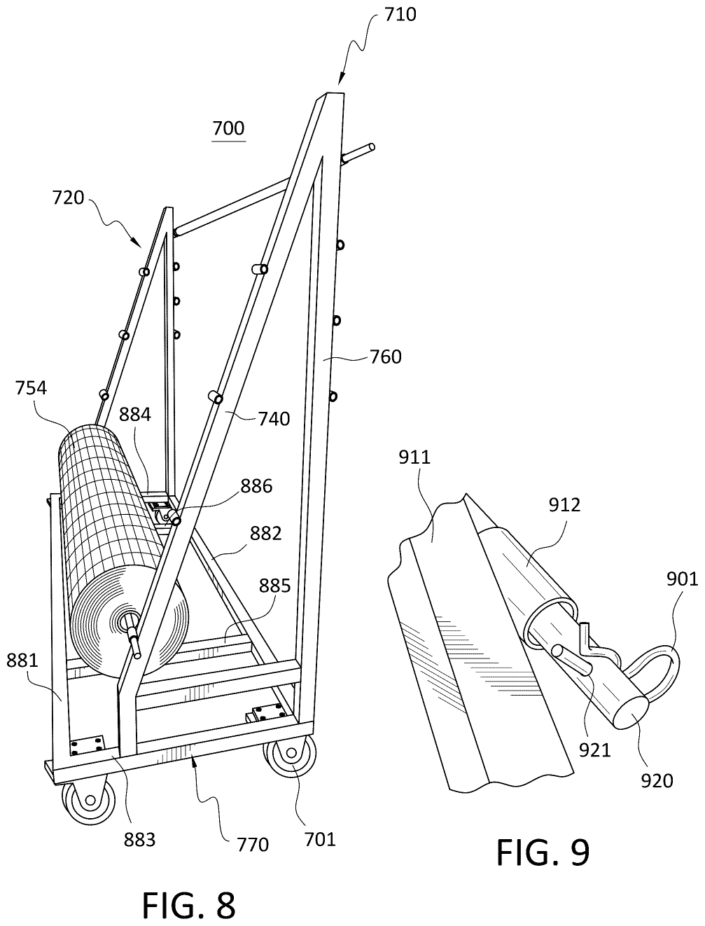

FIG. 7 illustrates a front view of a trellis mover 700, according to another embodiment. FIG. 8 illustrates a side view of trellis mover 700. Trellis mover 700 is similar to the trellis mover 100 (FIGS. 1-2), but can have a base 770, which can be a single large base that extends from end to end, instead of the separate bases (e.g., 210) at the bottom of the stands (e.g., 110, 120). In many embodiments, trellis mover 700 can include stands 710 and 720, each of which can include a diagonal brace 740 and an end brace 760. Stands 710 and 720 can be similar stands 110 and 120 (FIGS. 1-2), and various elements of stands 710 and 720 can be similar or identical to various elements of stands 110 and 120 (FIGS. 1-2). Diagonal brace 740 can be similar to diagonal brace 240 (FIG. 2), and various elements of diagonal brace 740 can be similar or identical to various elements of diagonal brace 240 (FIG. 2). End brace 760 can be similar to center brace 260 (FIG. 2), and various elements of end brace 760 can be similar or identical to various elements of center brace 260 (FIG. 2). As shown in FIG. 8, base 770 can include pieces 881-882 extended between end pieces 883-884, and interior support pieces 885-886 can extend between pieces 881-882. As shown in FIGS. 7-8, there are four wheels 701 attached to base 770. As shown in FIG. 7, trellis mover 700 can include (or hold) net guides 744 and 761, which can be similar or identical to net guides 141-144 and/or 161 (FIGS. 1-2), and net guide 744 can hold a roll of trellis 754.

FIG. 9 illustrates an example of an eyelet 912 on a brace 911, which can be similar or identical to eyelets 641-644 on diagonal brace 640 (FIG. 6), eyelets 661-664 on center brace 660 (FIG. 6), and the eyelets on diagonal brace 740 and end brace 760 of stand 710 of trellis mover 700 (FIG. 7). As shown in FIG. 9, an end of net guide 920 can extend through eyelet 912. In many embodiments, net guide 920 can be threaded through the eyelet 912 on braces 911 and secured from slipping out of eyelet 912, such as by using a cotter pin 901 in a hole 921 of net guide 920, or using another suitable mechanism. Net guide 920 can be similar or identical to net guides 141-144, 161 (FIGS. 1-2) and/or 744, 761 (FIG. 7).

In some embodiments, the wheels (e.g., 101 (FIG. 1), 701 (FIG. 7)) mounted to the bottom of the base (e.g., 210 (FIG. 2), 770 (FIG. 7)) can include casters for case of movement of the trellis mover and/or wheel locks to hold the trellis mover in place. In some embodiments, the trellis mover (e.g., 100 (FIG. 1), 700 (FIG. 7)) can be sized to fit through a standard doorway, such that it can be rolled into and around an indoor greenhouse.

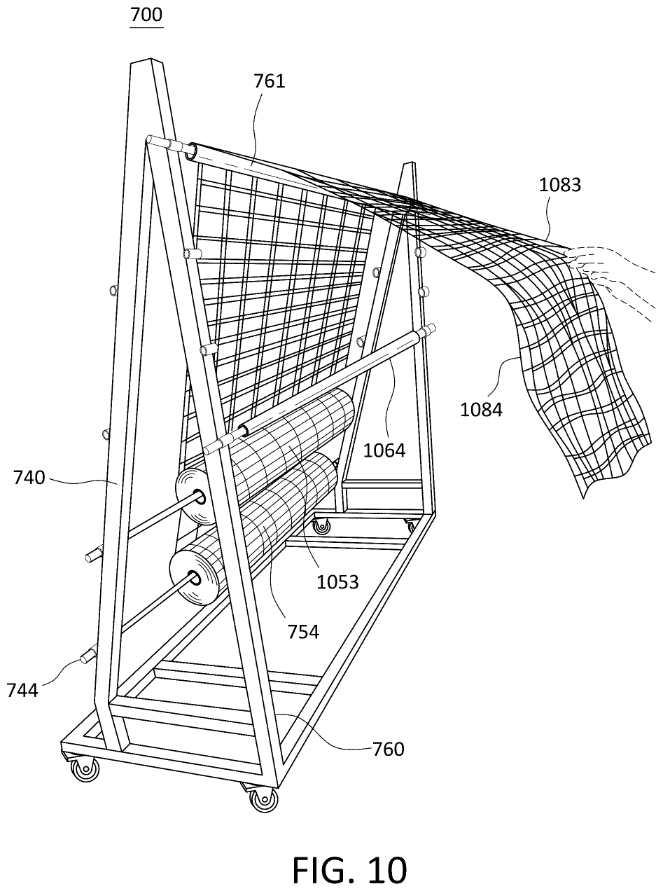

In many embodiments, the trellis mover can hold rolls of trellis that are various sizes, such as 4-foot-wide rolls, 4.5-foot-wide rolls, 5-foot-wide rolls, 5.5-foot-wide rolls, 6-foot-wide rolls, 6.5-foot-wide rolls, and/or other suitable sizes. As shown in FIG. 10, multiple rolls of trellis (e.g., 754, 1053) can be mounted on the trellis mover (e.g., 700) on a brace (e.g., 740), and various different net guides (e.g., 761, 1064) can be used on the opposite brace (e.g., 760) to set the dispensing height for layers of the trellis, such as at a 3-foot height, a 4-foot height, a 5-foot height, and a 6-foot height, as examples. As shown in FIG. 10, two layers of trellis 1083-1084 from two rolls (e.g., 754, 1053) can be dispensed over a net guide at the 6-foot height, and can be pulled by a person to dispense the trellis.

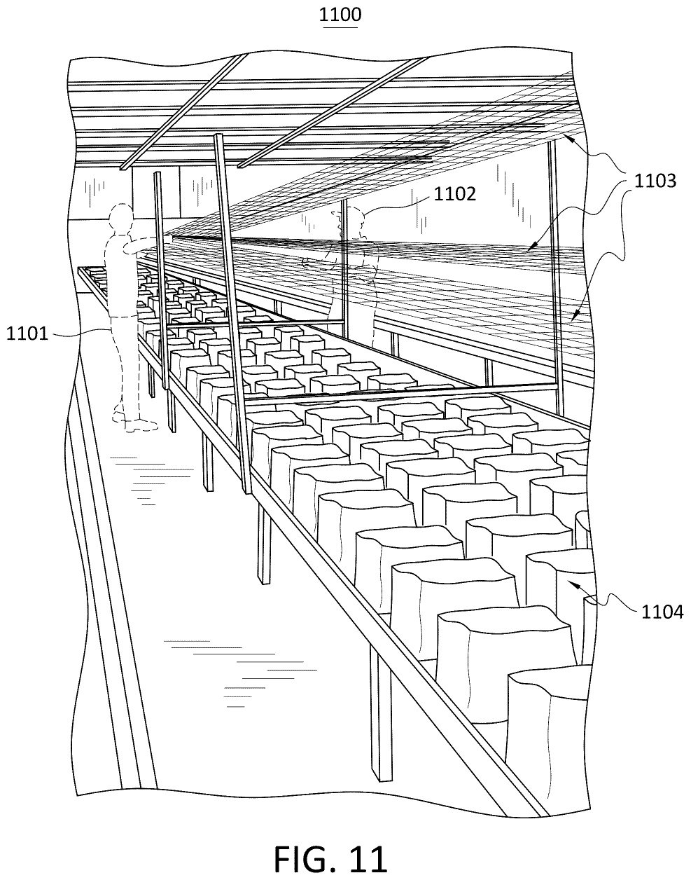

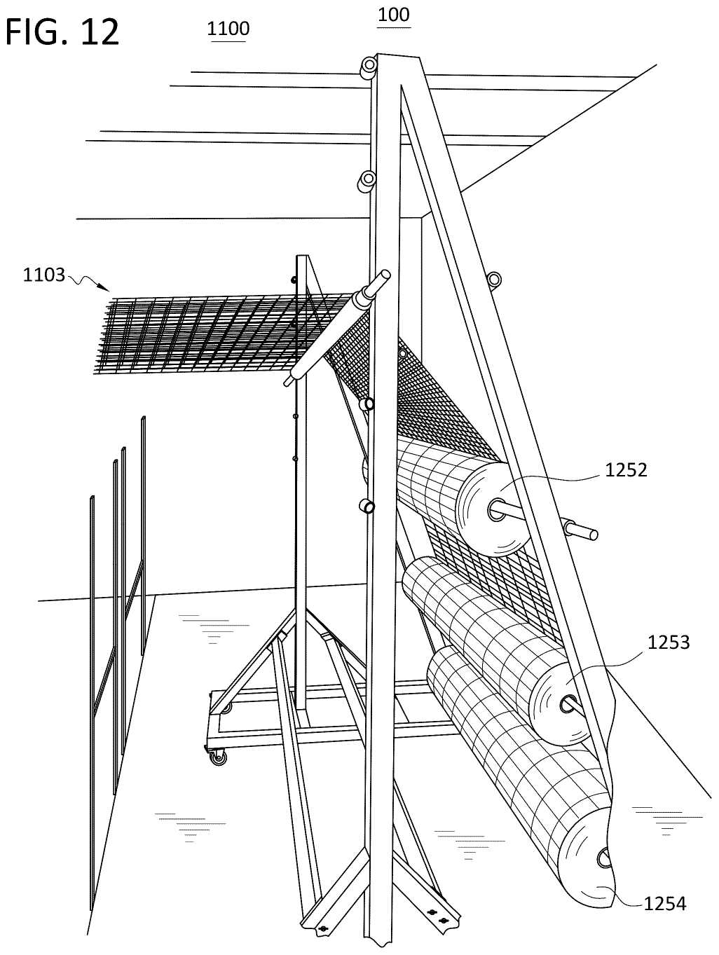

FIGS. 11-12 show an example of using trellis mover 100 to dispense three rolls of trellis 1252-1254 in layers 1103 in an indoor greenhouse 1100. In the example shown in FIGS. 11-12, two people 1101-1102 are pulling three layers 1103 of trellis down a row of plants 1104 to allow for installation of the layers 1103 of trellis at multiple different heights above the plants 1104.

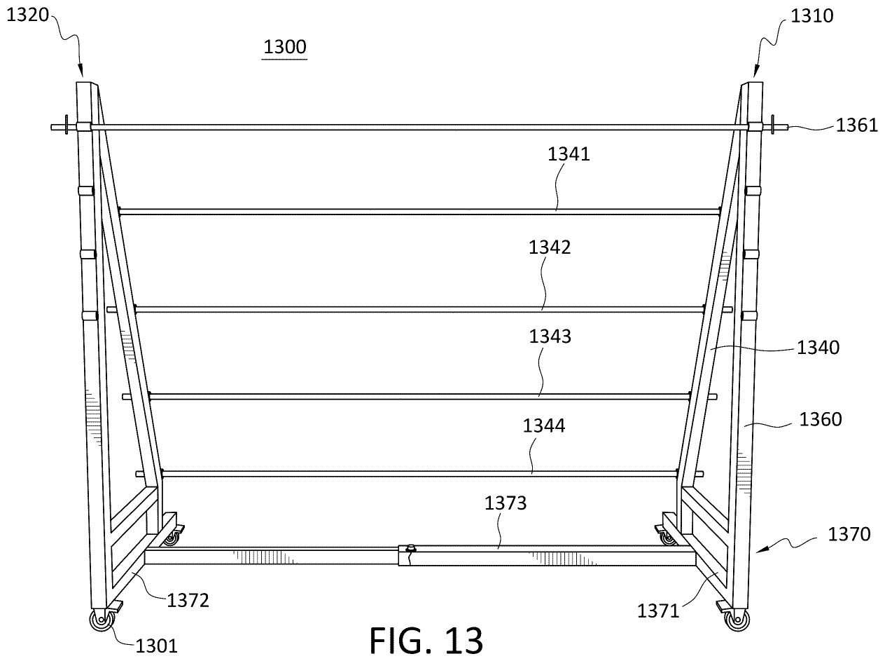

FIG. 13 illustrates a rear view of a trellis mover 1300, according to another embodiment. Trellis mover 1300 is similar to the trellis mover 700 (FIG. 7), but can have a base 1370 that has a narrower width along cross support 1373 between ends 1371-1372 than the width of base 770 along pieces 881-882. In many embodiments, trellis mover 1300 can include stands 1310 and 1320, each of which can include a diagonal brace 1340 and an end brace 1360. Stands 1310 and 1320 can be similar or identical to stands 710 and 720 (FIG. 7), and various elements of stands 1310 and 1320 can be similar or identical to various elements of stands 1310 and 1320 (FIG. 7). Diagonal brace 1340 can be similar or identical to diagonal brace 740 (FIG. 7), and various elements of diagonal brace 1340 can be similar or identical to various elements of diagonal brace 740 (FIG. 7). End brace 1360 can be similar to end brace 760 (FIG. 7), and various elements of end brace 1360 can be similar or identical to various elements of end brace 760 (FIG. 7). As shown in FIG. 13, base 1370 can include cross support 1373 extending between end pieces 1371-1372. As shown in FIG. 13, there are four wheels 1301 attached to base 1370. As shown in FIG. 13, trellis mover 1300 can include (or hold) net guides 1341-1344 and 1361, which can be similar or identical to net guides 141-144, 161 (FIGS. 1-2), and/or 744, 761 (FIG. 7).

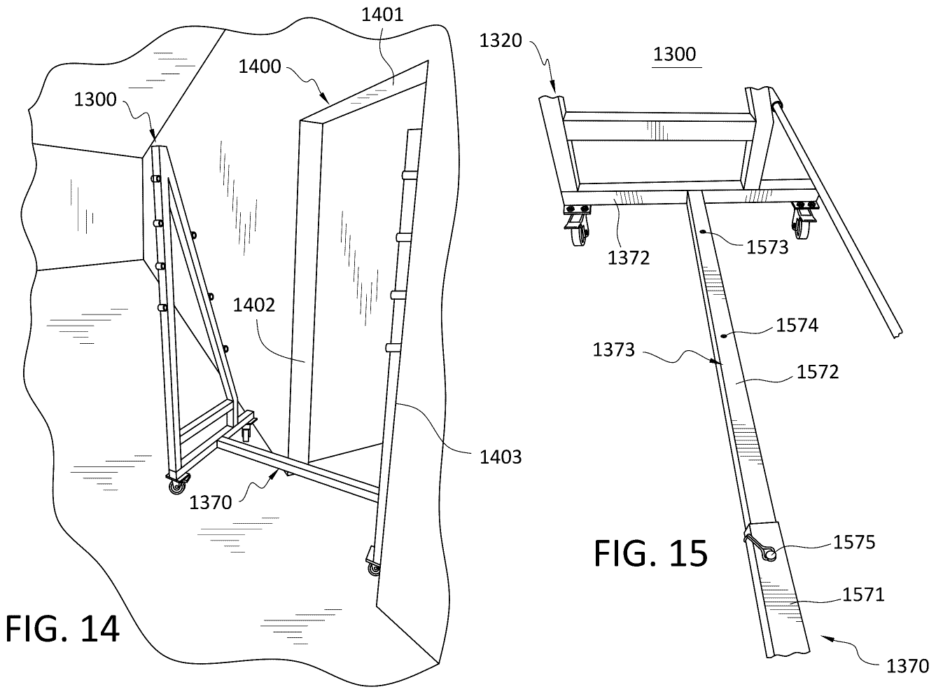

As shown in FIG. 14, the configuration of base 1370 can allow trellis mover 1300 to fit through a doorway (or narrow passageway) 1400, below a top 1401, and through sides 1402-1403, such as in an indoor greenhouse, and can make sharp turns (e.g., 90 degree turns moving from one hallway to another).

As shown in FIG. 15, cross support 1373 can be adjustable to allow stands 1310 and 1320 (FIG. 13) to be moved closer together or farther apart. Cross support 1373 can include a first piece 1571 connected to end piece 1371 (FIG. 13) at the base of stand 1310 (FIG. 13), and a second piece 1572 connected to end piece 1372 at the base of stand 1320. As shown in FIG. 15, second piece 1572 can slide within first piece 1571 to adjust to various different lengths, by using pin 1575 through a set hole of first piece 1571 and various different holes in second piece 1572, such as holes 1573-1574.

Embodiments of the trellis mover can provide significant benefits over conventional approaches. For example, at one large greenhouse, approximately 12 man-hours used to dispense the trellis of labor were decreased to approximately 2.5 man-hours, as reduction of labor of 80%.

Although the trellis mover and methods of providing and using the same have been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-15 may be modified, and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A dispensing rack comprising:
a first stand;
a second stand; and
a movable base,
wherein the first and second stands are configured to hold multiple rolls and dispense multiple layers simultaneously from the multiple rolls.

2. The dispensing rack of claim 1, wherein:
the first and second stands each comprise a respective first brace comprising respective first attachment mechanisms;
the respective first attachment mechanisms are configured to hold first guides for the multiple rolls; and
the first and second stands are configured to hold the multiple rolls using the first guides.

3. The dispensing rack of claim 2 further comprising the first guides.

4. The dispensing rack of claim 3, wherein the first guides are configured to be secured at the respective attachment mechanisms using cotter pins.

5. The dispensing rack of claim 2, wherein:
the first and second stands each comprise a respective second brace comprising second attachment mechanisms; and
the respective second attachment mechanisms are configured to hold second guides at respective dispensing heights for the multiple layers.

6. The dispensing rack of claim 1, wherein the movable base comprises four wheels.

7. The dispensing rack of claim 1 further comprising one or more cross-braces that extend between the first and second stands.

8. The dispensing rack of claim 7, wherein the one or more cross-braces are adjustable in length.

9. The dispensing rack of claim 1, wherein the first and second stands are configured to dispense at least four layers of trellis simultaneously from the multiple rolls.

10. The dispensing rack of claim 1, wherein:
the first and second stands each comprise a respective first brace comprising respective first attachment mechanisms;
the respective first attachment mechanisms are configured to hold first guides for the multiple rolls;
the first and second stands are configured to hold the multiple rolls using the first guides;
the first and second stands each comprise a respective second brace comprising second attachment mechanisms;
the respective second attachment mechanisms are configured to hold second guides at respective dispensing heights for the multiple layers.
the movable base comprises four wheels; and
the first and second stands are configured to dispense at least four layers of trellis simultaneously from the multiple rolls.
